(19) United States
(12) Patent Application Publication
(10) Pub. No.: US 2022/0309430 A1
(43) Pub. Date: Sep. 29, 2022

(54) System and Method for Hyperloop Traffic Demand Management

(71) Applicant: Hyperloop Technologies, Inc., Los Angeles, CA (US)

(72) Inventor: Dapeng Zhang, Covina, CA (US)

(73) Assignee: Hyperloop Technologies, Inc., Los Angeles, CA (US)

(21) Appl. No.: 17/591,605

(22) Filed: Feb. 3, 2022

Related U.S. Application Data
(60) Provisional application No. 63/165,821, filed on Mar. 25, 2021.

(51) Int. Cl. G06Q 10/06; G06Q 30/02; G06Q 50/16; G01C 21/34

(52) U.S. Cl. CPC G06Q 10/06315; G06Q 30/0205; G06Q 50/165; G01C 21/3423; G01C 21/3492

(57) ABSTRACT

A solution is disclosed for traffic demand management of a transportation network. The transportation network may comprise hyperloop modes of transportation as well as non-hyperloop modes of transportation. The solution is configured to generate a socio-economic model, a land use model, an accessibility model as well as a plurality of trip models. The solution further distributes trip models among a plurality of passengers and/or cargo in order to manage traffic within the transportation network. Non-hyperloop modalities may be further associated with the trip models in order to support “last mile” service between a hyperloop portal and an origin and/or destination.

### CROSS REFERENCE AND PRIORITY TO RELATED APPLICATIONS

This application claims the benefit of priority to: U.S. Provisional No. 63/165,821 entitled “SYSTEM AND METHOD FOR HYPERLOOP TRAFFIC DEMAND MANAGEMENT,” filed on Mar. 25, 2021.

All the aforementioned applications are hereby incorporated by reference in their entirety.

### BACKGROUND

Hyperloop is a passenger and cargo transportation system relying on a sealed tube and a bogie attached to a pod. The sealed tube has a substantially lower air pressure than the external environment. As such, the bogie and the attached pod may travel with reduced air resistance, thus increasing energy efficiency as well as performance. Further, the acceleration and the velocity of the bogie may be substantially higher than a comparable bogie operating within a gas environment having a higher pressure (including at standard air pressure of one atmosphere). Some hyperloop systems rely on magnetic levitation (sometimes referred to as “maglev”). The advantage of using maglev is a further reduction in friction viz. the resistance between a traditional wheel and a traditional track is eliminated by using a maglev-based bogie. Hyperloop is in the early stages of development and commercialization. However, the projected velocity of the bogie may exceed 700 mph (1,127 km/h) in commercialized implementations.

Trip optimization for hyperloop is a non-trivial problem to address. More optimized trip scheduling is generally desirable because operators can increase energy efficiency, decrease passenger wait times, decrease travel times, increase revenue from fares, etc. However, optimizing trip schedules is a difficult undertaking due to the complexity of traffic demand management and modeling. For each hyperloop pod sent into the hyperloop network, a subsequent departure may be affected. Further, the subsequent departure may further affect later departures, arrivals, or a combination thereof. Delayed hyperloop pods may increase traffic demand as trips (and deliveries) are being unsatisfied. Fares may then decrease as users will not pay for inefficient, delayed modes of travel such as a poorly optimized hyperloop network. Overall demand for hyperloop as a mode of transportation may decrease as well if needs cannot be consistently and reliably met. In short, traffic demand is both difficult to model as well as difficult to manage when in commercialized operation. Yet, traffic demand management plays a considerable role in any viable implementation of hyperloop.

Hyperloop networks are complex and are generally required to be implemented alongside other existing modes of transportation (e.g., car, bus, train, ship, etc.). Like other modes of transportation, trip scheduling and trip management may be required for hyperloop pods. Further, such trip scheduling may need to account for other modes of transportation and the existing scheduling algorithms associated therewith. For example, a hyperloop pod may need to be scheduled such that a traditional train is positioned to accept cargo and passengers from the arriving hyperloop pod. In sum, a hyperloop network and the associated traffic demand are difficult to manage given the existing modes of transportation interacting with the hyperloop network.

What is needed is a system and method for the management of traffic demand within a hyperloop network.

### SUMMARY

A method for traffic demand management of a transportation network is disclosed. The method comprises generating (at a processor) a socio-economic model, generating (at the processor) a land use model, generating (at the processor) an accessibility model, and generating (at the processor) a plurality of trip models. The plurality of trip models comprises a first trip model and a second trip model, wherein the first trip model and the second trip model are based on the socio-economic model, the land use model, the accessibility model, or a combination thereof. Further, the first trip model has a first hyperloop route associated therewith, and the second trip model has a second hyperloop route associated therewith. The method further comprises determining (at the processor) a trip distribution of the plurality of trip models, wherein the trip distribution is based on the first hyperloop route and the second hyperloop route. The method further comprises determining (at the processor) availability of one or more modes of non-hyperloop transportation, wherein the one or more modes of non-hyperloop transportation are associated with the first hyperloop route. The method further comprises assigning (at the processor) the first trip model to a passenger, a cargo unit, or a combination thereof, wherein the first trip model utilizes the one or more modes of non-hyperloop transportation that is determined to be available during a travel time associated with the first trip model. The method further comprises optimizing (at the processor) the first hyperloop route based on the one or more modes of non-hyperloop transportation.

The method further comprises executing (at the processor) an operational state, wherein the operational state causes a first hyperloop pod to travel along the first hyperloop route and a second hyperloop pod to travel along the second hyperloop route, wherein the operational state further notifies the one or more modes of non-hyperloop transportation of the travel time associated with the first trip model. The method further comprises updating (at the processor) the land use model based on the operational state and updating (at the processor) the accessibility model based on the operational state. The method further comprises presenting, at a user interface, the execution of the operational state, wherein the operational state is configured to be managed by a user.

The method may further comprise detecting (at the processor) a level of congestion within the first hyperloop route and assigning (at the processor) the first trip model to a third hyperloop route, wherein the third hyperloop route is less congested than the first hyperloop route.

A computing device for traffic demand management of a transportation network is disclosed, wherein the computing device has a memory, a processor, and a user interface. The processor may be configured to generate a socio-economic model, generate a land use model, generate an accessibility model, and generate a plurality of trip models. The plurality of trip models comprises a first trip model and a second trip model, wherein the first trip model and the second trip model are based on the socio-economic model, the land-use model, the accessibility model, or a combination thereof. Further, the first trip model has a first hyperloop route associated therewith, and the second trip model has a second hyperloop route associated therewith. The processor is further configured to determine a trip distribution of the plurality of trip models, wherein the trip distribution is based on the first hyperloop route and the second hyperloop route. The processor is further configured to determine availability of one or more modes of non-hyperloop transportation, wherein the one or more modes of non-hyperloop transportation are associated with the first hyperloop route. The processor is further configured to assign the first trip model to a passenger, a cargo unit, or a combination thereof, wherein the first trip model utilizes the one or more modes of non-hyperloop transportation that is determined to be available during a travel time associated with the first trip model. The processor is further configured to optimize the first hyperloop route based on the one or more modes of non-hyperloop transportation.

The processor may be further configured to execute an operational state, wherein the operational state causes a first hyperloop pod to travel along the first hyperloop route and a second hyperloop pod to travel along the second hyperloop route, wherein the operational state further notifies the one or more modes of non-hyperloop transportation of the travel time associated with the first trip model. The processor is further configured to update the land use model based on the operational state and update the accessibility model based on the operational state. The processor is further configured to present, at the user interface, the execution of the operational state, wherein the operational state is configured to be managed by a user.

The processor may further be configured to detect a level of congestion within the first hyperloop route and assign the first trip model to a third hyperloop route, wherein the third hyperloop route is less congested than the first hyperloop route.

A computer-readable medium is disclosed wherein the computer-readable medium stores instructions that, when executed by a computer, cause the computer to further generate a socio-economic model, generate a land use model, generate an accessibility model, and generate a plurality of trip models. The plurality of trip models comprises a first trip model and a second trip model, wherein the first trip model and the second trip model are based on the socio-economic model, the land-use model, the accessibility model, or a combination thereof. Further, the first trip model has a first hyperloop route associated therewith, and the second trip model has a second hyperloop route associated therewith. The computer-readable medium is further configured to determine a trip distribution of the plurality of trip models, wherein the trip distribution is based on the first hyperloop route and the second hyperloop route. The computer-readable medium is further configured to determine availability of one or more modes of non-hyperloop transportation, wherein the one or more modes of non-hyperloop transportation are associated with the first hyperloop route. The computer-readable medium is further configured to assign the first trip model to a passenger, a cargo unit, or a combination thereof, wherein the first trip model utilizes the one or more modes of non-hyperloop transportation that is determined to be available during a travel time associated with the first trip model. The computer-readable medium is further configured to optimize the first hyperloop route based on the one or more modes of non-hyperloop transportation.

The computer-readable medium is further configured to execute an operational state, wherein the operational state causes a first hyperloop pod to travel along the first hyperloop route and a second hyperloop pod to travel along the second hyperloop route, wherein the operational state further notifies the one or more modes of non-hyperloop transportation of the travel time associated with the first trip model. The computer-readable medium is further configured to update the land use model based on the operational state and update the accessibility model based on the operational state. The computer-readable medium is further configured to present, at a user interface, the execution of the operational state, wherein the operational state is configured to be managed by a user.

The computer-readable medium is further configured to detect a level of congestion within the first hyperloop route and assign the first trip model to a third hyperloop route, wherein the third hyperloop route is less congested than the first hyperloop route.

The one or more modes of non-hyperloop transportation may be associated with a non-hyperloop route between a hyperloop portal and a non-hyperloop-portal destination. Further, the one or more modes of non-hyperloop transportation may be selected from the group consisting of: ridesharing, carpool, taxi, automobile, train, trolley, airplane, ship, and ferry. The socio-economic model may be based on socio-economic data selected from the group consisting of: population size, employment rate, types of employment, household sizes, number of vehicles per household, income within a region, income sources per household, and existing modes of transportation.

The land use model may be based on land use data selected from the group consisting of: land density, land diversity, land value, taxes, zoning, accessibility, existing infrastructure, and encumbrances. The accessibility model may be based on accessibility data selected from the group consisting of: travel duration, portal locations, route locations, road locations, rail locations, port locations, airport locations, housing locations, commercial locations, industrial locations, and government locations.

### BRIEF DESCRIPTION OF DRAWINGS

The accompanying drawings, which are incorporated herein and constitute part of this specification, illustrate exemplary aspects of the claims, and together with the general description given above and the detailed description given below, serve to explain the features of the claims.

FIG. 1A is a block diagram illustrating a transportation network.

FIG. 1B is a block diagram illustrating a transportation network.

FIG. 1C is a block diagram illustrating a transportation network.

FIG. 1D is a block diagram illustrating a transportation network.

FIG. 2A is a block diagram of a traffic demand system configured to manage a transportation network.

FIG. 2B is a block diagram of a traffic demand system configured to manage a transportation network.

FIG. 2C is a block diagram of a data structure comprising a socio-economic model, a land use model, an accessibility model, and a plurality of trip models.

FIG. 3 is a flowchart of a process for managing the traffic demand of a transportation network.

FIG. 4 is a block diagram illustrating an example server suitable for use with the various aspects described herein.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Hyperloop is an evolving technology that can address many existing problems in the transportation industry. Some problems facing the industry include: long travel times, unpredictable delays, safety risks, fossil fuel emissions, reliance on human personnel for operations, high energy demands, etc. Further, hyperloop has the ability to address problems facing the transportation industry of the future (e.g., addressing traffic congestion, updating obsolete infrastructure, avoiding non-optimal fare assignment, etc.)

Understanding traffic demand is a necessary requirement for hyperloop as well as existing modes of transportation. Specifically, hyperloop will require modeling and management of traffic demand in order to be commercially successful. Without such traffic modeling, operators and investors will have low confidence in the viability of a hyperloop network that is proposed for deployment because operators and investors require some confidence level in order to undertake the high capital costs of hyperloop deployment. Further, operators may require robust traffic demand modeling in order to properly manage a hyperloop network in operation.

However, traffic demand management may require consideration of a number of factors that may or may not be related. Further, such factors may have non-linear relationships that have even more non-linear interactions with other factors. Some factors include, but are not limited to: socio-economic constraints, land use constraints, trip distribution requirements, transportation mode allocation (to both existing modes and hyperloop), trip assignment modeling, accessibility constraints, route optimization, and ongoing operations.

Socio-economic constraints may relate to a number of factors generally associated with the traffic demand of hyperloop as well as the capabilities of passengers and cargo to pay the costs to meet said traffic demand. In general, people require transportation, whether for work or pleasure. Hyperloop will require revenue from passenger and cargo trips that are predominately served by non-hyperloop modes of transportation. However, if hyperloop is deployed in a region without the ability to pay for said trips, the hyperloop network may not be economically viable. The converse may also be true—if socio-economic conditions are such that affluent passengers are simply not interested in public (or semi-public) transportation modes (like hyperloop), the associated hyperloop network may likewise not be economically viable. Socio-economic considerations may affect traffic demand. The disclosed solution provides for evaluation, modeling, and management of socio-economic constraints such that traffic demand may be evaluated, modelled, and managed.

Land use constraints are a constraint facing any mode of transportation, whether hyperloop or non-hyperloop. Automobiles require roads. Trains require rails. Planes require runways. Likewise, hyperloop will require land for deployment of associated infrastructure, often referred to as “hyperstructure.” Hyperstructure is generally defined as portals, tube structures, vacuum systems, and support structures (to name a few components) that enable hyperloop travel. Hyperloop has an additional requirement beyond track deployment because hyperloop relies on hyperloop portals that serve a similar function as existing train stations today viz. loading and unloading passengers and cargo. Land use constraints may affect traffic demand because hyperloop service may be limited by existing land use limitations. For instance, a small area of land near an airport may be desirable from a traffic demand aspect but undesirable from a land acquisition aspect because the capital expenditure costs may exceed planned budgets. The disclosed solution provides for evaluation, modeling, and management of land use constraints such that traffic demand may be evaluated, modelled, and managed.

Trip distribution requirements generally relate to determining how to allocate hyperloop trips to hyperloop pods and hyperloop portals. If a particular hyperloop portal becomes too congested, hyperloop traffic demand may be negatively affected. For example, passengers may cancel trips in order to utilize other modes of travel; such a situation is not desirable because passengers may refund fares, thus reducing revenue for operators. Likewise, passengers who face delays and cancellations will gravitate toward other non-hyperloop modes of travel. Therefore, distributing trips of hyperloop pods with respect to use of hyperloop portals is generally improved with more optimized trip distribution. Effective traffic demand may need to consider the effects of trip distributions. However, trip distribution is a non-trivial problem that requires coordination among various factors (e.g., time of day, origin locations, destination locations, passenger demand, cargo demand, portal configuration, pod availability, etc.). The disclosed solution is configured to provide evaluation, modeling, and management of trip distribution in order to support traffic demand evaluation, modeling, and management.

Traffic demand is affected by the allocation of various transportation modes. As with trip allocation, the allocation of a particular mode to a trip is of substantially similar importance. Modern cities rely on a complex network of heterogeneous modes of transportation (e.g., bus, trolley, automobile, airplane, taxi, etc.). Many passengers utilize several modes of transportation in a single day. For example, a commuter may begin travel in an automobile before travelling via train to an airport (to depart via airplane). As hyperloop becomes more ubiquitous, passengers will likewise integrate hyperloop into the use of various, non-hyperloop modes of transportation. Given that trip scheduling is already complex, the addition of another factor (i.e., mode allocation) only contributes to the difficulty of proper mode allocation. The disclosed solution provides for the evaluation, modeling, and management of mode allocation in order to evaluate, model, and manage traffic demand.

Trip assignment is the act of assigning passengers and cargo to particular hyperloop pods associated with a certain route and time. In some situations, trip assignment may include non-hyperloop modes of transportation that are associated with a hyperloop-based trip. For every trip assigned, the traffic demand is likewise affected. For instance, allocating a group of passengers to an oversaturated route may negatively affect traffic demand by adding additional congestion to the oversaturated route. Without properly allocated trip assignments, traffic demand cannot be addressed since trip assignments are the mechanism to serve a modelled traffic demand. The disclosed solution provides for evaluation, modeling, and management of trip allocation such that traffic demand may be evaluated, modelled, and managed.

Accessibility constraints generally relate to how a particular passenger (or unit of cargo) may reach the hyperloop network. Hyperloop portal deployment is constrained by land use and socio-economic considerations. As such, reaching hyperloop portals by existing modes may be more or less difficult depending on the operating environment. For example, a large hyperloop portal connected by a narrow highway may constrain the hyperloop portal. On the other hand, hyperloop networks with high accessibility may have an adverse effect on traffic demand. For instance, a hyperloop portal may be accessible to such a degree that the demand for other portals decreases, thus causing underutilization of the other portals. The disclosed solution provides for evaluation, modeling, and management of accessibility constraints in order to evaluate, model, and manage traffic demand.

Route constraints may affect traffic demand because every route has a physical limitation defined by the land use, pod availability, hyperstructure capabilities, energy availability, portal configuration, etc. Trip assignment is particularly related to route constraints. For example, assigning a trip to a route that lacks capacity may cause a trip to become delayed or cancelled. Route constraints may also affect accessibility modeling because a portal may be virtually unreachable if route constraints cause travel to the portal to be unviable. The disclosed solution provides for the evaluation, modeling, and management of route constraints such that traffic demand may be evaluated, modelled, and managed.

In sum, the disclosed traffic demand management solution may address many of the aforementioned problems, limitations, and constraints, all of which affect the hyperloop network. Further, the disclosed traffic demand management solution enables the future growth and adoption of hyperloop transportation by providing a solution that is socio-economically viable, enabled by land use restrictions, supported by hyperloop infrastructure, and economically feasible for operators. Thus, hyperloop operators and investors will have the confidence necessary to deploy an expensive hyperloop network.

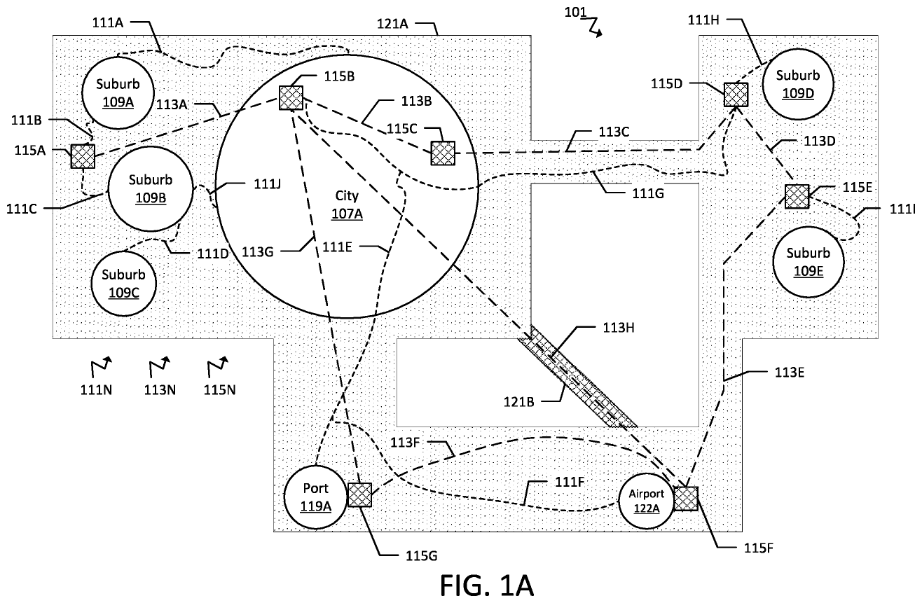

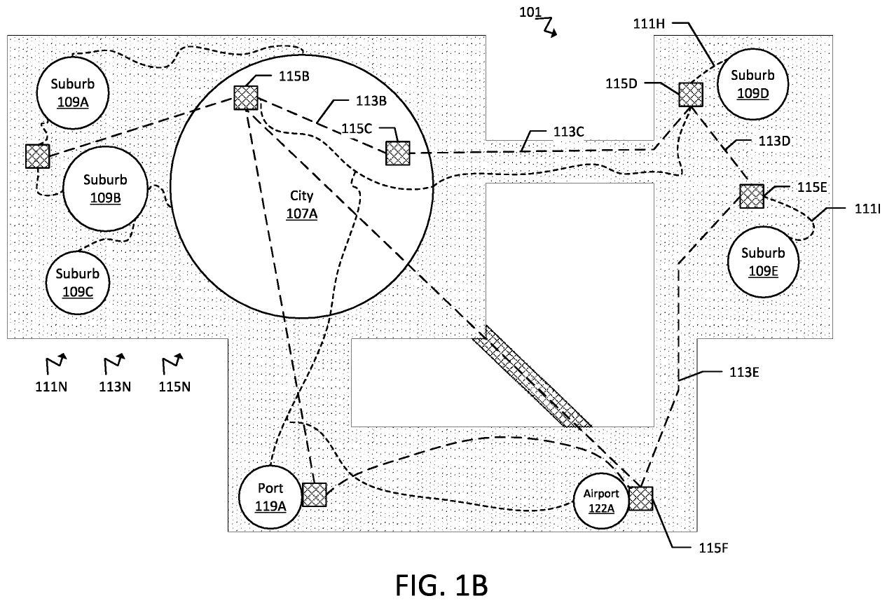

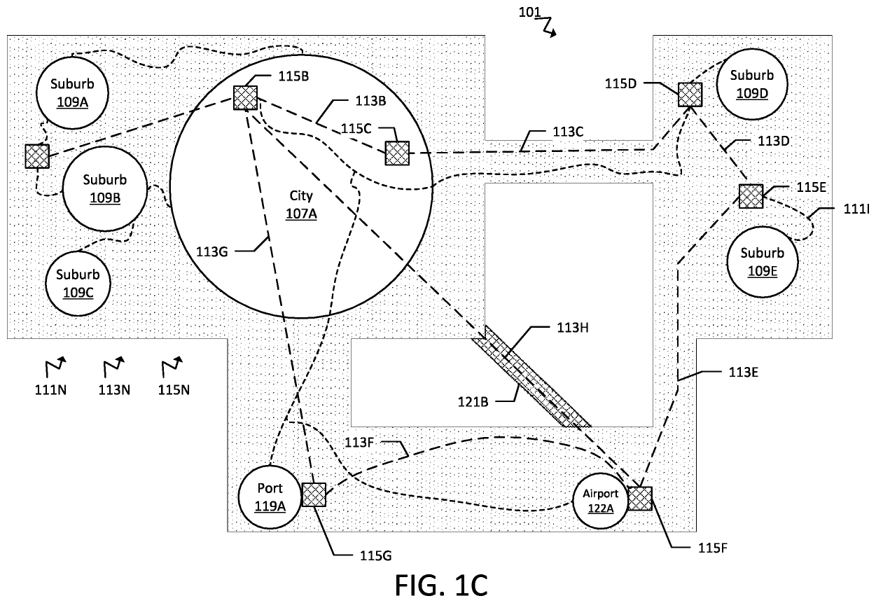

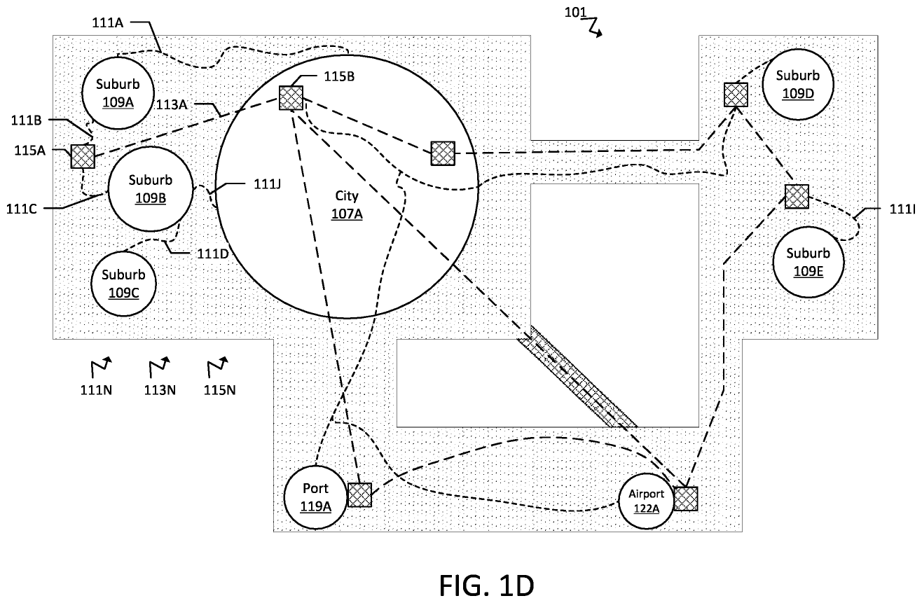

FIG. 1A is a block diagram illustrating a transportation network 101. The transportation network 101 may be deployed within a land area 121A. The land area 121A may be defined by a number of parameters. For instance, the land area 121A may be defined by land that is owned, purchasable, and/or liquid. In some areas of the world, land is unavailable for use as the land may be designated as a nature preserve, in which case no transportation mode may be deployed therein. In another situation, the land may be unavailable for purchase due to competing economic uses (e.g., an industrial company is using the land for extraction of mineral resources). As such, the land outside the shaded land area 121A may be considered unusable by the transportation network 101.

A city 107A may be disposed on the land area 121A. The city 107A may be considered a large city (e.g., London, Mumbai, etc.). As such, the city 107A may be connected by a myriad of transportation modes including rail, automobile, ship, etc. Many cities are surrounded by smaller municipalities or suburbs. For illustrative purposes, the cities and suburbs referred to herein should generally be considered relative and not exact. For instance, a suburb in China may be considered a large city in Eastern Europe or Australia. One of skill in the art will appreciate that some metropolitan areas are large and some are small.

The land area 121A may have a first suburb 109A, a second suburb 109B, a third suburb 109C, a fourth suburb 109D, and a fifth suburb 109E. The suburbs 109A, 109B, 109C, 109D, 109E may be generally considered metropolitan areas that are smaller in both size and population than a similarly situated city (e.g., the city 107A). In one aspect, the suburbs 109A, 109B, 109C, 109D, 109E may generally be considered single-use areas of land, e.g., a particular suburb may be substantially residential while another suburb may be substantially commercial. On the other hand, the city 107A may be of mixed use where residential, commercial, and industrial use all coexist.

The transportation network 101 may have a first portal 115A, a second portal 115B, a third portal 115C, a fourth portal 115D, a fifth portal 115E, a sixth portal 115F, and a seventh portal 115G. The portals 115A, 115B, 115C, 115D, 115E, 115F, 115G may form a plurality of portals 115N. The plurality of portals 115N are locations where a hyperloop pod may perform a number of actions, including but not limited to: load passengers, unload passengers, load cargo, unload cargo, perform maintenance, remove pods from service, add pods to service, change operating personnel, etc. One of skill in the art will appreciate that the plurality of portals 115N may have slightly different functionality but perform many similar functions. For example, a seaport coupled to a portal may have many of the characteristics of a seaport and a train station, plus the unique aspects of hyperloop (e.g., emission-less vehicles, moving platforms, high speeds, etc.).

The transportation network 101 may have a port 119A. The port 119A may be generally operable to dock ships at berths, in one aspect. For example, cargo is predominately transported by sea via container-based cargo ships. When cargo ships dock, the cargo containers are unloaded onto dry land. Traditionally, a semi-truck arrives with a trailer to receive and deliver cargo containers.

The transportation network may have an airport 122A. The airport 122A is generally operable to enable air-based modes of transportation (e.g., airplane, helicopter, etc.). In the instant example, the airport 122A serves the city 107A, the port 119A, and the suburbs 109A, 109B, 109C, 109D, 109E.

The portal 115A may be connected to the portal 115B via a route 113A. The route 113A is generally operable to provide an operating environment for the hyperloop pod. The route 113A, for instance, may be comprised of an elevated series of pylons that support an above-ground tube, i.e., a hyperstructure. Within the tube, a near-vacuum pressure environment provides lowered air resistance, thus increasing velocity, energy efficiency, etc. In another aspect, the route 113A may be subterranean and contained within a similar tube as the above-ground example above. While the route 113A, and many other similar illustrations, are denoted with substantially straight lines, one of skill in the art will appreciate that natural curves and turns would be present for a hyperstructure in a commercial deployment.

A route 113B connects the portal 115B to the portal 115C. A route 113C may connect the portal 115C to the portal 115D. A route 113D may connect the portal 115D to the portal 115E. A route 113E may connect the portal 115E to the portal 115F. A route 113F may connect the portal 115F to the portal 115G. A route 113G may connect the portal 115G to the portal 115B. A route 113H may connect the portal 115F, near the airport 122A, to the portal 115B. The route 113H may be disposed along a land area 121B. The land area 121B may be considered a congested area of land that has minimal room for additional hyperloop tracks disposed along the route 113H. On the one hand, the route 113H provides substantially direct access between the airport 122A and the city 107A. On the other hand, the route 113H may become quickly overwhelmed by traffic demand, due in part to the narrowness of the land area 121B.

The routes 113A, 113B, 113C, 113D, 113E, 113F, 113G may form a plurality of routes 113N having substantially similar characteristics. One of skill in the art will appreciate that the plurality of portals 115N and the plurality of routes 113N are used for illustrative purposes and may have multiple instances within a particular location. For instance, the portal 115A may be comprised of three smaller portals (not shown) that form a discrete transportation network. The plurality of routes 113N may be comprised of hyperstructure that may be subterranean, underwater, on-ground, above-ground, or a combination thereof.

A plurality of roads 111N may be comprised of a first road 111A, a second road 111B, a third road 111C, a fourth road 111D, a fifth road 111E, a sixth road 111F, a seventh road 111G, an eighth road 111H, a ninth road 111I, and a tenth road 111J. The plurality of roads 111N may support any existing mode of ground transportation, including, but not limited to, automobile, rail, trolley, subway, bus, or a combination thereof. In modernized cities, high-speed rail may be considered a right-of-way user of the plurality of roads 111N. One of skill in the art will appreciate the plurality of roads 111N is utilized for illustrative purposes and may, in one aspect, simply be the means by which an existing, non-hyperloop vehicle travels.

The road 111A may connect the suburb 109A to the city 107A. The road 111B may connect the portal 115A to the suburb 109A. The road 111C may connect the portal 115A to the suburb 109B. The road 111D may connect the suburb 109B to the suburb 109C. The road 111E may connect the port 119A to the city 107A. The road 111F may connect the airport 122A to the road 111E. The road 111G may connect the city 107A to the portal 115D. The road 111H may connect the portal 115D to the suburb 109D. The road 111I may connect the portal 115E to the suburb 109E. The road 111J may connect the city 107A to the suburb 109B.

In one aspect, the suburbs 109A, 109B, 109C, 109D, 109E are connected to the city 107A. In many metropolitan areas, people reside in suburbs and commute to larger city centers. The cities generally have more commercial and industrial opportunities for workers. Stated differently, the land use in the suburbs 109A, 109B, 109C, 109D, 109E may be quite different than that of the city 107A because the suburbs 109A, 109B, 109C, 109D, 109E are primarily residential, and the city 107A is mixed-use. One reason for the difference is simply the land use density viz. city use is denser than suburban use.

In one aspect, the hyperloop portal 115A is an example of how the suburbs 109A, 109B may utilize hyperloop. For instance, a worker living in the suburb 109A may take the road 111B to the portal 115A where the worker may park the car in a garage. Then, the worker may use the hyperloop route 113A to arrive at the portal 115B within the city 107A. The worker could then walk to a nearby place of work (e.g., an office complex).

In another example, the hyperloop portal 115E is positioned at the right side of the land area 121A. One of skill in the art will appreciate that most of the suburbs 109A, 109B, 109C, 109D, 109E are connected by the plurality of roads 111N. However, the introduction of the hyperloop portal 115E in the righthand area of the land area 121A provides an opportunity for land use at and around the hyperloop portal 115E.

The plurality of roads 111N and the plurality of routes 113N form a mesh by redundantly connecting many points within the transportation network 101 (e.g., the suburb 109B has several entries and exits). In contrast, the portal 115E is only connected by the hyperloop route 113D. Such a deployment is an example of how a hyperloop portal may encourage growth in an underutilized area of land. A new, efficient mode of transportation like hyperloop may encourage people in the city 107A to purchase land in the vicinity of the portal 115E in order to avoid congestion, noise, pollution, inadequate schools, crime, etc. However, such increase in population density may correspondingly increase traffic demand.

The topology of the transportation network 101 is influenced by a number of factors. For example, the suburb 109E may be connected to the road 111I that leads to the portal 115E. One of skill in the art will appreciate how the use of roads to and from the suburb 109E is minimal due to (1) the proximity of the portal 115E and (2) the suburb 109E being built with the portal 115E as a primary mode of transportation for the area. Therefore, the inhabitants of the suburb 109E largely rely on hyperloop for transportation needs when traveling beyond the nearby area of the suburb 109E. As such, the inhabitants of the suburb 109E may rely on fewer transportation modes. In contrast, the inhabitants of city 107A have multiple points of access to roads and hyperloop routes. Such considerations may affect traffic demand viz. inhabitants in the suburb 109E may place more demand on the hyperloop routes in the vicinity of the suburb 109E compared to roads in the same area.

A hyperloop portal 115F is positioned substantially near the airport 122A to illustrate that in some implementations, a portal may be tightly coupled to a nearby location. In the instant example, the airport 122A may unload passengers, near the portal 115F, directly into hyperloop pods traveling toward the city 107A. A portal 115G is shown as being tightly coupled to the port 119A. In one aspect, cargo ships docking at the port 119A may unload cargo containers bound for the city 107A. Prior to the introduction of the portal 115G, cargo had to be caned via the road 111E using traditional semi-trucks.

The route 113G may connect the portal 115G to the portal 115B. The route 113G may be specially configured to carry cargo-laden pods, that are destined for the city 107A, in one aspect. In another aspect, the pods traveling along the route 113G may be a mix of passenger-configured and cargo-configured pods. The route 113F may connect the portal 115G to the portal 115F and may be utilized for a combination of passenger and cargo traffic. For instance, passengers may arrive at the airport 122A, enter the portal 115F, travel via the route 113F to the portal 115G, and finally travel along the route 113G to arrive at the portal 115B. In another example, cargo may be offloaded from airplane at the airport 122A and then be transported to the port 119A via the route 113F. Likewise, the cargo may be transported between the port 119A and the city 107A (or to any other destination).

FIG. 1B is a block diagram illustrating the transportation network 101. The instant figure is substantially similar to FIG. 1A above. However, some reference labels have been omitted in order to further illustrate the disclosed solution as operating on a real-world example. One of skill in the art will appreciate that the unlabeled parts still maintain the same references as described above in FIG. 1A.

FIG. 1C is a block diagram illustrating the transportation network 101. The instant figure is substantially similar to FIG. 1A above. However, some reference labels have been omitted in order to further illustrate the disclosed solution as operating on a real-world example. One of skill in the art will appreciate that the unlabeled parts still maintain the same references as described above in FIG. 1A.

FIG. 1D is a block diagram illustrating the transportation network 101. The instant figure is substantially similar to FIG. 1A above. However, some reference labels have been omitted in order to further illustrate the disclosed solution as operating on a real-world example. One of skill in the art will appreciate that the unlabeled parts still maintain the same references as described above in FIG. 1A.

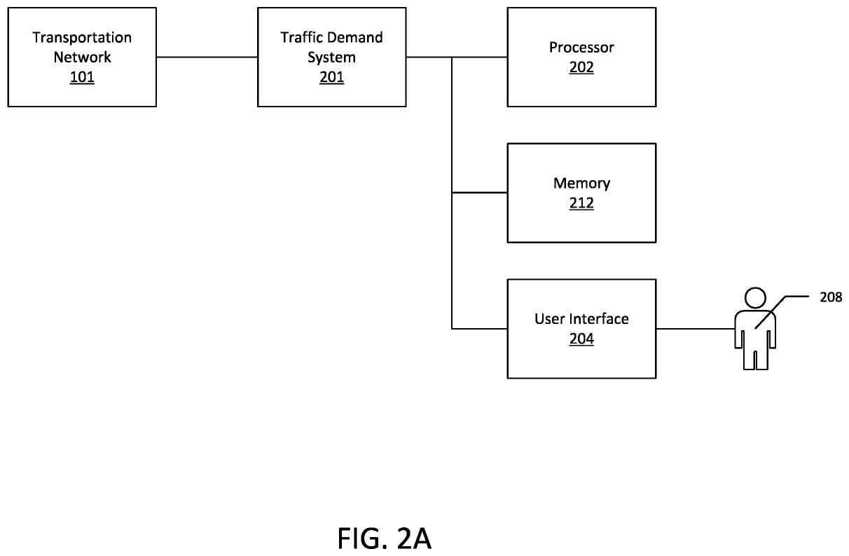

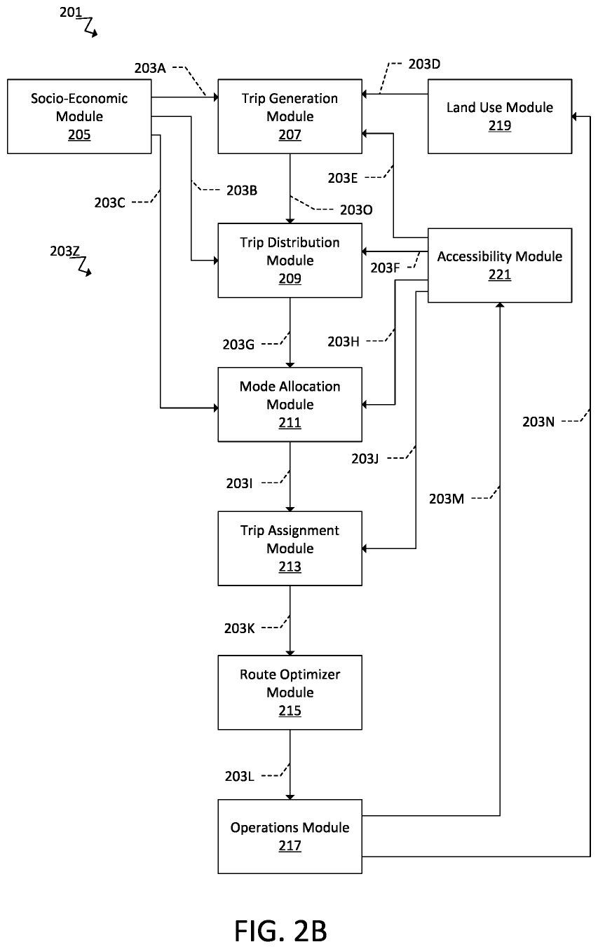

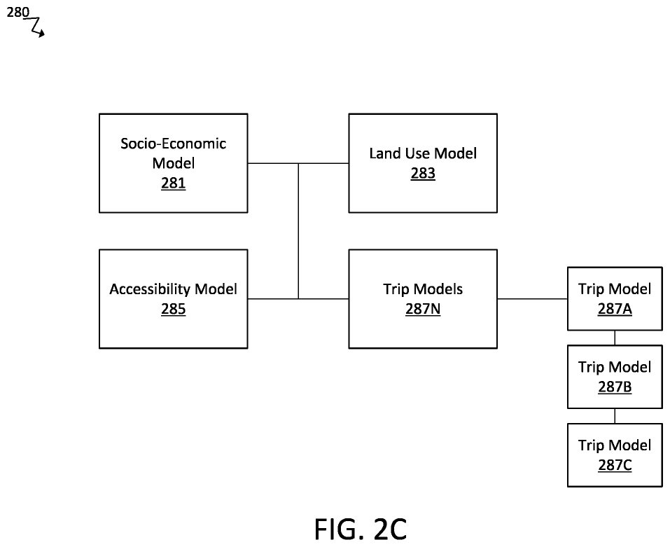

FIG. 2A is a block diagram of a traffic demand system 201 configured to manage the transportation network 101. The traffic demand system 201 is generally configured to manage the transportation network 101 via modeling, evaluation, and management of traffic demand. The traffic demand system 201 may be in communication with a processor 202, a memory 212, and a user interface 204. Further, the user interface 204 may be used by a user 208.

The processor 202 may be a shared processor which is utilized by other systems, modules, etc. within the disclosed solution. For example, the processor 202 may be configured as a general-purpose processor (e.g., x86, ARM, etc.) that is configured to manage operations from many disparate systems, including the traffic demand system 201. In another aspect, the processor 202 may be an abstraction because any of the modules, systems, or components disclosed herein may have a local processor (or controller) that handles aspects of the traffic demand system 201 (e.g., ASICs, FPGAs, etc.).

The memory 212 is generally operable to store and retrieve information. The memory 212 may be comprised of volatile memory, non-volatile memory, or a combination thereof. The memory 212 may be closely coupled to the processor 202, in one aspect. For example, the memory 212 may be a cache that is co-located with the processor 202. As with the processor 202, the memory 212 may, in one aspect, be an abstraction wherein the modules, systems, and components each have a memory that acts in concert across the traffic demand system 201.

The user interface 204 is generally configured to enable the user 208 to view, manipulate, store, print, transfer, and/or receive data and information related to inputs and outputs of the traffic demand system 201. For example, the user interface 204 may be a desktop computer configured to use software embodying the traffic demand system 201. Further, the software may be a web-based, interactive application that provides the user 208 with a heat map of areas (in the land area 121A) that have higher traffic demand compared to other areas. For instance, the port 119A may have higher traffic demand and thus be shown to the user 208 who is interacting with the user interface 204 (which may be keyboard, mouse, and display). One of skill in the art will appreciate that the user interface 204 may be a laptop, a desktop, a tablet, a smartphone, a web-based application, a desktop application, a mobile application, or a combination thereof.

FIG. 2B is a block diagram of the traffic demand system 201 configured to manage the transportation network 101. The traffic demand system 201 may be software-implemented, hardware-implemented, or a combination thereof. For example, the traffic demand system 201 may run on a standalone server, a cloud-based server, a distributed computation network, etc. In another aspect, the traffic demand system 201 may be implemented in hardware. For example, the traffic demand system 201 may be implemented using field-programable gate arrays, application-specific integrated circuits, etc.

In one aspect, the traffic demand system 201 may manage a subset of the various modes of transportation. For instance, the traffic demand system 201 may perform management of ridesharing and hyperloop modes of transportation but may not manage traditional rail and trolley modes of transportation (since those modes may be controlled by legacy systems). The traffic demand system 201 may be in communication with the transportation network 101 via a number of sensors and transceivers located within the infrastructure (or “hyperstructure”), the hyperloop pods, the hyperloop portals, etc. In one aspect, the user 208 may communicate with elements of the transportation network 101 via the user interface 204.

The traffic demand system 201 may include a number of modules that are interconnected viz. a socio-economic module 205, a trip generation module 207, a trip distribution module 209, a mode allocation module 211, an accessibility module 221, a trip assignment module 213, a route optimizer module 215, and an operations module 217.

The traffic demand system 201 may utilize logical links between two or more modules. For example, a link may be a data structure containing instructions for a remote module to interpret and execute. In one aspect, a link may be more localized within a particular computing device when one or more modules are logically linked within a computer program product. In another aspect, a link may be utilized between two modules that are executing in different computers. In still another aspect, a link may have a user-interactable capability such that the user 208 may interact with the data in the link via the user interface 204. For example, the traffic demand system 201 may communicate a plurality of models from one module to another module while enabling the user 208 to view the models via the user interface 204.

The socio-economic module 205 is connected to the trip generation module 207 via a link 203A. The socio-economic module 205 is connected to the trip distribution module 209 via a link 203B. The socio-economic module 205 is connected to the mode allocation module 211 via a link 203C. The land use module 219 is connected to the trip generation module 207 via a link 203D. The accessibility module 221 is connected to the trip generation module 207 via a link 203E. The accessibility module 221 is connected to the trip distribution module 209 via a link 203F. The accessibility module 221 is connected to the mode allocation module 211 via a link 203H. The accessibility module 221 is connected to the trip assignment module 213 via a link 203J.

The trip generation module 207 is connected to the trip distribution module 209 via a link 203O. The trip distribution module 209 is connected to the mode allocation module 211 via a link 203G. The mode allocation module 211 is connected to the trip assignment module 213 via a link 203I. The trip assignment module 213 is connected to the route optimizer module 215 via a link 203K. The route optimizer module 215 is connected to the operations module 217 via a link 203L.

The operations module 217 is connected to the accessibility module 221 via a link 203M. The operations module 217 is connected to the land use module 219 via a link 203N. One of skill in the art will appreciate that the links 203A, 203B, 203C, 203D, 203E, 203F, 203G, 203H, 203I, 203J, 203K, 203L, 203M, 203N, 203O may form a plurality of links 203Z. Further, one of skill in the art will appreciate that the plurality of links 203Z, when viewed together, form a feedback loop wherein the inputs of one module may be informed by outputs of other modules. Such a feedback loop enables the traffic demand system 201 to adapt to the dynamic nature of the transportation network 101 as well as the dynamic nature of the traffic demand. Further, the disclosed configuration of the traffic demand system 201 may be enabled in a neural network capable of machine-learning that is operable to perform the processes, algorithms, operations, and instructions disclosed herein. For instance, the processor 202 and the memory 212 may form a neural network that is configured to execute the processes and algorithms of the traffic demand system 201.

The socio-economic module 205 is generally configured to determine the socio-economic aspects affecting traffic demand. At a high-level, traffic demand is affected by the individuals who utilize the transportation network 101. Traffic demand may relate to passenger travel, cargo transportation, or a combination thereof. In any case, the human element has an effect on the traffic demand of the transportation network 101, and the socio-economic module 205 is designed with the aim of understanding the behavior and demands of users by analyzing the socio-economic forces that motivate said users.

The socio-economic module 205 may receive master-planning schematics in order to determine the locality of nearby residential, commercial, and industrials districts. For example, cities have vast databases of land parcels that are divided into zones which dictate the permitted uses of the zoned land. Further, the socio-economic module 205 may correlate financial values to the various districts represented within the master-planning schematics. For instance, the socio-economic module 205 may determine that the suburb 109E has a higher household income. In certain circumstances, wealthier passengers may opt to purchase first-class fares to the airport 122A where such fares carry a higher profit margin for the operators of the transportation network 101, specifically hyperloop modalities within the transportation network 101. As a counterexample, the residents of the suburb 109B may be low-income factory workers who commute to the city 107A in order to work in an industrial area. As such, said workers may seek lower fares in more congested sections of the hyperloop pod (e.g., “economy” class). One of skill in the art will appreciate that socio-economic factors affect many aspects beyond fares, including cabin choice, trip duration, “last mile” service, amenities, frequency of travel, etc.

In another aspect, the socio-economic module 205 may gather information from public census data. Some information may not be represented in master-planning schematics. However, key aspects of population demographics may be ascertained from census data. For instance, census data may inform the socio-economic module 205 what the average household size is within a particular region. For instance, the suburb 109B may have a relatively higher number of residents per household. The socio-economic module 205 may accept as input the higher density of residents within the suburb 109B when determining traffic demand because the road 111J may not be able to serve the suburb 109B. As such, the socio-economic module 205 may mark such high-population areas as having high traffic demand such that the traffic demand system 201 may utilize the information processed by the socio-economic module 205.

The socio-economic module 205 may output information to the trip generation module via the link 203A. Such output information may be population size, employment rate, types of employment, household sizes, number of vehicles per household, income of an entire region, income sources per household, existing modes of transportation in use, etc. Further, the socio-economic module 205 may output similar information, via the link 203B, to the trip distribution module 209. Still further, the socio-economic module 205 may output similar information, to the mode allocation module 211, via the link 203C.

The trip generation module 207 is generally configured to generate a trip for a particular hyperloop pod carrying passengers, cargo, or a combination thereof. The trip generation module 207 may be further configured to manage a fleet of hyperloop pods. In one aspect, the management of the fleet of hyperloop pods may include convoying operations wherein a series of hyperloop pods are managed in concert.

A trip may be generally defined as movement from one point to another point while having some type of cost associated therewith (e.g., a fare, a toll, etc.). Trips may be short or long. Further, trips may pass through multiple hyperloop portals prior to reaching a final destination. In one aspect, a trip may include modes of transportation that are peripheral to hyperloop but temporally connected to a hyperloop-based trip. For example, a cargo container may arrive at a port via ship and be unloaded onto a hyperloop pod, that carries the cargo container to a waiting semi-truck for pickup.

As an example, in FIG. 1B above, a trip may be planned from the portal 115B to the suburb 109E. The trip may begin at the portal 115B, travel along the route 113B, pass through the hyperloop portal 115C, travel along the route 113C, pass through the hyperloop portal 115D, travel along the route 113D, and stop at the hyperloop portal 115E. Further, the trip may include a rideshare from the hyperloop portal 115E, to the suburb 109E, via the road 111I. One of skill in the art will appreciate that other, non-hyperloop modalities may participate in a particular trip (e.g., trolley, bicycle, taxi, ferry, etc.).

The trip generation module 207 may utilize input from the land use module 219 as received via that link 203D. For example, the trip generation module 207 may process land use to determine trip generation. An example from FIG. 1C above may be illustrative. The route 113H is disposed along a narrow corridor defined by the land area 121B. If the land area 121B is near a nature preserve, the operators may not be able to expand the route 113H beyond existing boundaries. As such, the trip generation module 207 may take into consideration such limitations when generating a trip via the route 113H. For instance, the trip generation module 207 may actively avoid sending pods to the route 113H if the pod is not at or near full capacity.

The land use module 219 is generally configured to determine land use, as described above. Land use is an important consideration for trip generation because ground-based travel necessarily requires land upon which to operate. The land use module 219 may manage information relating to land density, land diversity, land value, parcel size, parcel position, zoning, etc. The land use module 219 may pass output via the link 203D to the trip generation module 207.

One of skill in the art can appreciate from FIG. 1A that the land areas 121A, 121B are irregular shapes that do not necessarily facilitate straight layouts of routes. Further, the land areas 121A, 121B have natural features that further limit route configurations (e.g., hills, lakes, etc.). As such, the land use module 219 may output land use information (via the link 203D) to the trip generation module 207 as part of trip planning. For instance, some trips may require navigation up and down grades which affects energy efficiency as well as passenger comfort. Such land-based considerations, when addressed, may improve trip generation and resulting traffic demand managed by the traffic demand system 201. For instance, increasing energy efficiency may imply fewer delays related to charging the batteries onboard the pods.

The accessibility module 221 is generally operable to determine travel time, portal locations, fares, non-hyperloop accessibility (e.g., car), walkability, etc. In one aspect, the accessibility module 221 may include logic to take into account the socio-economic outputs received from the socio-economic module 205. For example, passengers in an industrial area may prefer to drive but often use hyperloop on days when roads are overly congested. As such, the accessibility module 221 may adjust trips and fares according to the unique demand of said passengers, since traffic delays (and travel time) are pronounced on certain days of the week.

The accessibility module 221 may create a plurality of accessibility models to enable processing by the trip generation module 207, the trip distribution module 209, the mode allocation module 211, and the trip assignment module 213, as shown by the links 203E, 203F, 203H, 203J. Accessibility data may relate to travel time, portal locations, route locations, road locations, rail locations, port locations, airport locations, ridesharing portals, etc. In one aspect, the accessibility data may be sent as output to other modules. The user 208 may view such data via the user interface 204.

The trip distribution module 209 is generally configured to determine the number of trips between an origin and a destination. As disclosed above, a trip may be planned from point to point. However, the planning of multiple trips occurring at substantially the same time may require additional factors that the trip distribution module 211 may address via processing the input received from the trip generation module 207, the socio-economic module 205, and the accessibility module 221.

As shown in the FIG. 1C above, if too many trips are planned along the route 113H, the route 113H may become overly congested. As such, the trip distribution module 209 may allocate additional trips to the routes 113G, 113F such that congestion along the route 113H may be alleviated. In one aspect, the trip distribution module 209 may utilize the information received via the link 203B from the socio-economic module 205 in order to determine the viability of rerouting a trip.

The mode allocation module 211 is generally configured to assign various modes of transportation to trips. Further, the mode allocation module 211 may assign fares to trips (including multimodal trips). In one aspect, the mode allocation module 211 may determine scheduling of trips such that an optimized schedule is generated, both with respect to hyperloop as well as other, non-hyperloop modalities (e.g., ridesharing from a hyperloop portal to the home of a passenger). The mode allocation module 211 may receive input from the accessibility module 221, the trip distribution module 209, and the socio-economic module 205.

As an example, the trip distribution module 209 may assign a trip to a cargo container received at the port 119A. The trip may consist of a cargo container travelling from the port 119A to the suburb 109D. The mode allocation module 211 may assign a hyperloop pod to receive the cargo container at the portal 115G. When the pod arrives at the portal 115D, the mode allocation module 211 may assign a semi-truck to the arriving pod such that the semi-truck may receive the cargo. The semi-truck may then navigate to the suburb 109D via the road 111H based on data from the traffic demand system 201.

The trip assignment module 213 is generally configured to assign trips on each route and manage the topology of the transportation network 101. For example, the trip assignment module 213 may coordinate with the trip distribution module 209 such that a particular route is not overutilized or underutilized. The trip assignment module 213 may receive input from the mode allocation module 211 and the accessibility module 221. In one aspect, the trip assignment module 213 may receive mode allocations from the mode allocation module 211 such that a particular mode is associated with a trip, a passenger, a cargo unit, or a combination thereof. Since the traffic demand system 201 is configured to manage several modes of transportation, the trip assignment module 213 may manage both hyperloop and non-hyperloop modalities.

The route optimizer module 215 is generally configured to optimize the route of travel within a given trip. The route optimizer module 215 may optimize a route to reach one or more goals of optimization. For example, a goal may be to minimize the number of stops on a trip. Another example of a goal may be to minimize travel time. Other goals may be related to: pod capacity, peak velocity, safety risk, length of travel, fare pricing, accessibility, alternative mode usage, or a combination thereof.

For example, in FIG. 1C above, the route optimizer module 215 may determine that the routes 113C, 113D, 113E, 113F are being overutilized. As such, the route optimizer module 215 may propose the route 113H as a means to reduce reliance on the routes 113C, 113D, 113E, 113F. In one aspect, the route optimizer module 215 may propose new routes (as with the route 113H). The user 208 may manually adjust and interact with routes via the user interface 204.

The operations module 217 is generally configured to manage the ongoing operations of the transportation network 101. Once trips are generated and assigned to the transportation network 101, the operations module 217 may manage the trips in order to make adjustments based on a number of factors, including, but not limited to: number of active trips, fare pricing, fare allocation, travel duration, departure schedules, arrival schedules, maintenance schedules, pod stabling, emergency operations, route optimization, operation costs, accessibility constraints, land use, trip distribution, or a combination thereof.

As an example, shown in FIG. 1D above, the operations module 217 may determine that the route 113A has been compromised due to a safety issue. The operations module 217 may communicate with the mode allocation module 211 to route passengers and cargo to the roads 111A, 111J. While not optimal for the hyperloop operator of the route 113A, such rerouting via other travel modalities may increase passenger satisfaction and therefore improve hyperloop adoption.

FIG. 2C is a block diagram of a traffic demand data structure 280 comprising a socio-economic model 281, a land use model 283, an accessibility model 285, and a plurality of trip models 287N. The plurality of trip models 287N comprise a first trip model 287A, a second trip model 287B, and a third trip model 287C. The traffic demand data structure 280 may be utilized by the traffic demand system 201 in order to manage the operations of the transportation network 101.

As shown in FIG. 2B above, the modules within the traffic demand system 201 are configured to perform a number of operations and functions. Such operations and functions may need to be logically and even physically embodied in a format that enables information and data to be exchanged—a model offers such functionality for the traffic demand system 201. A model may be a data structure containing real-world data that is operable on real-world components. For example, a model may contain the average household income of a particular region that is correlated to household size. Further, said model may be utilized by the trip generation module 207 to prepare and issue a travel fare based on information relating to the ability of the passenger to accept the price of said fare.

A model may be updated, shared, reconfigured, expanded, contracted, etc. In one aspect, a model may encapsulate input, output, analytics, or a combination thereof. One of skill in the art will appreciate that a model may be embodied in many forms and formats while still encoding necessary data and information for the traffic demand system 201. In one aspect, a model may be instructions or operations for a computer (e.g., the processor 202 and the memory 212 coupled together). In one aspect, the user 208 may interact and manage a model via the user interface 204.

The socio-economic model 281 is generally configured to include information relating to population size, employment data, household size, vehicles per household, income of passengers, income per capita, income sources per household, etc. The socio-economic module 205 may be configured to manage the socio-economic model 281 via operations of the processor 202 and the memory 212.

The land use model 283 is generally configured to include information relating to land density, land diversity, land value, taxes, zoning, accessibility, existing infrastructure, encumbrances, or a combination thereof. The land use module 219 may be configured to manage the land use model 283 via operations of the processor 202 and the memory 212.

The accessibility model 285 is generally configured to store information relating to a number of accessibility data including, but not limited to: travel duration, portal locations, route locations, road locations, port locations, airport locations, housing locations, commercial locations, industrial locations, government locations, etc. The accessibility module 221 may be configured to manage the accessibility model 285 via operations of the processor 202 and the memory 212.

The trip models 287A, 287B, 287C are generally configured to store information related to a trip. Reference shall be made to the trip model 287A, but one of skill in the art will appreciate that the trip models 287A, 287B, 287C are substantially similar. The trip model 287A may be associated with a passenger, a cargo unit, or a combination thereof. The trip model 287A may specify which modes of travel are to be utilized (including both hyperloop and non-hyperloop modalities). The trip model 287A may be based on a number of criteria, including distance traveled, fare per kilometer, number of stops, time of day, existing traffic demand, modalities used, maintenance schedules, pod availability, weather conditions, safety considerations, pod capacity, route capacity, passenger assignment, cargo assignment, etc. Since the plurality of trip models 287N comprises many trip models, the traffic demand system 201 is configured to manage key elements of the transportation network 101.

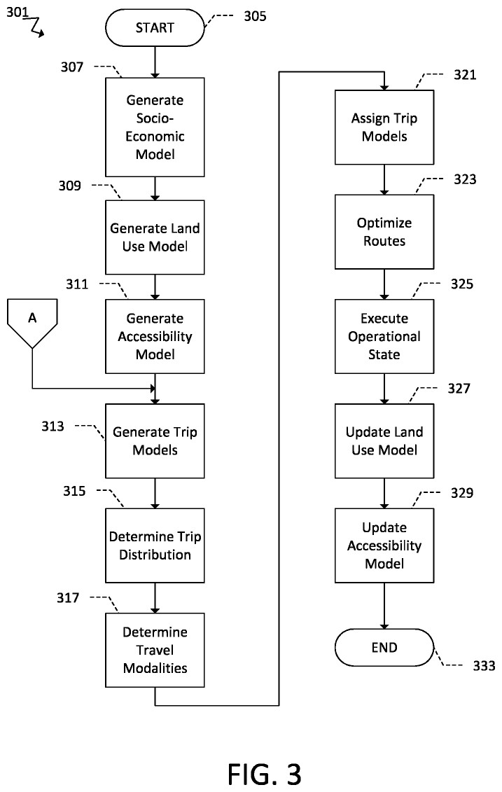

FIG. 3 is a flowchart of a process 301 for managing the traffic demand of the transportation network 101. The process 301 generates a number of data structures and models which relate to different aspects of the traffic demand system 201 in operation. In one aspect, the process 301 may generate the traffic demand data structure 280 as well as the socio-economic model 281, the land use model 283, the accessibility model 285, and the plurality of trip models 287N. Likewise, the process 301 may utilize the traffic demand system 201.

The process 301 begins at the start block 305 and proceeds to the block 307. At the block 307, the process 301 generates the socio-economic model 281. The socio-economic model 281 may be generated at the socio-economic module 205. The process 301 then proceeds to the block 309. At the block 309, the process 301 generates the land use model 283. The land use model 283 may be generated at the land use module 219. The process 301 then proceeds to the block 311.

At the block 311, the process 301 generates the accessibility model 285. The accessibility model 285 may be generated at the accessibility module 221. The process 301 then proceeds to the block 313.

At the block 313, the process 301 generates the plurality of trip models 287N. The plurality of trip models 287N may be generated by the trip generation module 207. In one aspect, the process 301 generates the plurality of trip models 287N based on the output from the socio-economic module 205, the land use module 219, and/or the accessibility module 221. Such output may be the socio-economic model 281, the land use model 283, and the accessibility model 285 as generated at the blocks 307, 309, 311, respectively. The process 301 then proceeds to the block 315.

At the block 315, the process 301 determines the trip distribution for the plurality of trip models 287N generated at the block 313. The process 301 may determine trip distribution using the trip distribution module 209. In one aspect, the trip distribution may be determined by the number of trips (in the plurality of trip models 287N) between two or more points within the transportation network 101.

For instance, in FIG. 1D, the routes 113E, 113F, 113H each service the portal 115F, which lies in proximity to the airport 122A. As such, the process 301 may utilize the trip distribution module 209 to allocate trips to each of the routes 113E, 113F, 113H such that one particular route does not become congested and negatively affect traffic demand in the transportation network 101. The allocation of a given trip to a given route may be stored in the plurality of trip models 287C from the block 313. The process 301 may store, in the trip models 287A, 287B, 287C, route usage for subsequent processing by the route optimizer module 215. As described above, when a route becomes overly congested, the route optimizer module 215 may be utilized by the process 301 to optimize the route utilized by a given trip. The process 301 then proceeds to the block 317.

At the block 317, the process 301 determines the travel modalities for the plurality of trip models 287N generated at the block 313. The process 301 may, in one aspect, utilize the mode allocation module 211. Modern travel is often multimodal. For instance, a traveler may use a train to arrive at a hyperloop portal, a hyperloop pod to arrive at a second hyperloop portal, and finally a car to drive from the second hyperloop portal to a residence. The process 301 may use a trip distributed at the block 315 in order to determine how alternative modes of transportation may be utilized to improve the trip even after distribution. For example, the process 301 may recommend that travelers utilize nearby buses during weekdays to avoid excessive traffic near a hyperloop portal due to work-related commutes.

The determination of trip modalities may include the assignment of fares based on additional, non-hyperloop modalities associated with a trip (e.g., as stored in the trip model 287A). As an example, from FIG. 1B above, the process 301 may determine that a passenger arriving at the hyperloop portal 115D may require ridesharing to reach the suburb 109D via the road 111H; often, automobile travel is required for the “last mile” of travel from the portal 115D to a final destination. Such a ridesharing event may have an associated fare that may be incorporated into the fare of the hyperloop portion of the trip. As such, operators may be able to monetize non-hyperloop modes of travel while simultaneously improving the passenger experience by offering a single fare for multimodal travel. The process 301 then proceeds to the block 321.

At the block 321, the process 301 assigns a trip model to a passenger or unit of cargo. Trip assignment may be performed by the trip assignment module 213, in one aspect. Given the complexity of the transportation network 101, the process 301 may be required to determine the number of trips on a given route for the purposes of optimizing routes and managing overall traffic demand.

As an example, from FIG. 1C, a rush-hour commute from the city 107A to the suburb 109E may be accomplished via any one of the following: (1) the routes 113B, 113C, 113D, (2) the routes 113E, 113H, or (3) the routes 113E, 113F, 113G. The process 301 may determine which set of routes will reach the suburb 109E most efficiently relative to other options. For instance, the route 113H may become overly congested due to the narrowness of the land area 121B. As such, the process 301 may route traffic to the routes 113E, 113F, 113G to avoid use of the route 113H during rush hour. While the routes 113E, 113F, 113G require longer distances to be traveled, the delay to the passengers may be reduced compared to waiting for the route 113H to become less congested.

At the block 323, the process 301 optimizes the routes within the plurality of trip models 287N. In one aspect, the process 301 utilizes the route optimizer module 215. Routes may be updated based on a number of factors. For instance, some hyperloop routes may support bidirectional travel along the same track. Therefore, the process 301 may determine both the use and direction of a particular route. In another aspect, the process 301 may gather data relating to existing route usage in order to further optimize route topologies such that travel time is reduced and energy efficiency is improved. In one aspect, the user 208 may perform high-level optimization of routes via the user interface 204. The process 301 then proceeds to the block 325.

At the block 325, the process 301 executes the operational state. In one aspect, the operations module 217 may be utilized by the process 301 in order to execute the operational state viz. manage, monitor, update, and control the transportation network 101. In one aspect, the process 301 is continuously executing within the operations module 217 such that changes within any module within the traffic demand system 201 may be received and acted upon, if necessary. In one aspect, the user 208 is interacting with the operational module 217 in order to manage the transportation network 101. The process 301 then proceeds to the block 327.

At the block 327, the process 301 updates the land use model 283. Land use is in constant flux, be it in usage, cost, or access. As such, the process 301 may update the traffic demand system 201 with updated land use via the land use module 219. In one aspect, the process 301 may utilize the link 203D to update the trip generation module 207 within the traffic demand system 201. In another aspect, the user 208 may utilize the user interface 204 in order to further manipulate and interact with the land use model 283. The process 301 then proceeds to the block 329.

At the block 329, the process 301 updates the accessibility model 285. The process 301 may utilize the accessibility module 221 to update the various modules in the traffic demand system 201 via the links 203E, 203F, 203H, 203J. Updated accessibility model data may include changes to fares, changes in portal locations, updated route availability, construction of new routes, etc. The process 301 then proceeds to the end block 333 and terminates.

As shown in the instant figure, Reference A is shown to indicate that the process 301 may be iterative for many trips without processing the operations within the blocks 307, 309, 311. One of skill in the art will appreciate that trip generation and management is highly time-dependent in some operating environments, including hyperloop operation. Further, certain variables may be less dynamic than others. For example, the socio-economic model 281 may be far less dynamic than the plurality of trip models 287N which is under constant change due to the nature of complex, multimodal transportation. As such, Reference A denotes a logical starting point for addressing the more dynamic models in the process 301. One of skill in the art will appreciate that the process 301 disclosed herein is merely illustrative and may have different but substantially similar instances in commercial deployment. For example, the land use model 283 may not be required for a particular commercial deployment if the land use is fixed by government order that grants a cost-free lease to land upon which hyperstructure may be built but prohibits acquisition of more land by hyperloop operators.

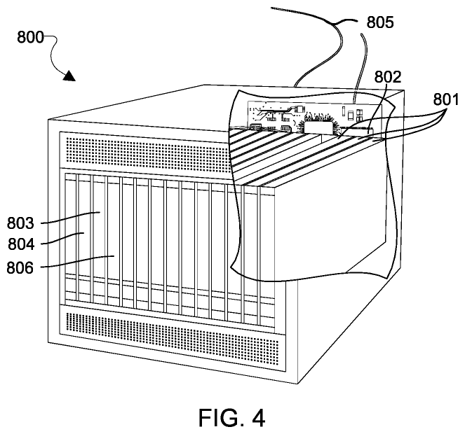

FIG. 4 is a block diagram illustrating a server 800 suitable for use with the various aspects described herein. In one aspect, the server 800 is operable to execute the traffic demand system 201 as well as execute the process 301. Further, the server 800 may process and store the traffic demand data structure 280. The server 800 may include one or more processor assemblies 801 (e.g., an x86 processor) coupled to volatile memory 802 (e.g., DRAM) and a large capacity nonvolatile memory 804 (e.g., a magnetic disk drive, a flash disk drive, etc.). As illustrated in instant figure, processor assemblies 801 may be added to the server 800 by inserting them into the racks of the assembly. The server 800 may also include an optical drive 806 coupled to the processor 801. The server 800 may also include a network access interface 803 (e.g., an ethernet card, WIFI card, etc.) coupled to the processor assemblies 801 for establishing network interface connections with a network 805. The network 805 may be a local area network, the Internet, the public switched telephone network, and/or a cellular data network (e.g., LTE, 5G, etc.).

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. A method for traffic demand management of a transportation network, the method comprising:
generating, at a processor, a socio-economic model;
generating, at the processor, a land use model;
generating, at the processor, an accessibility model;
generating, at the processor, a plurality of trip models, the plurality of trip models comprising a first trip model and a second trip model, the first trip model and the second trip model being based on the socio-economic model, the land use model, the accessibility model, or a combination thereof, the first trip model further having a first hyperloop route associated therewith, the second trip model further having a second hyperloop route associated therewith;
determining, at the processor, a trip distribution of the plurality of trip models, the trip distribution being based on the first hyperloop route and the second hyperloop route;
determining, at the processor, availability of one or more modes of non-hyperloop transportation, the one or more modes of non-hyperloop transportation being associated with the first hyperloop route;
assigning, at the processor, the first trip model to a passenger, a cargo unit, or a combination thereof, the first trip model utilizing the one or more modes of non-hyperloop transportation determined to be available during a travel time associated with the first trip model; and
optimizing, at the processor, the first hyperloop route based on the one or more modes of non-hyperloop transportation.

2. The method of claim 1, the method further comprising:
executing, at the processor, an operational state, the operational state causing a first hyperloop pod to travel along the first hyperloop route and a second hyperloop pod to travel along the second hyperloop route, the operational state further notifying the one or more modes of non-hyperloop transportation of the travel time associated with the first trip model;
updating, at the processor, the land use model based on the operational state; and
updating, at the processor, the accessibility model based on the operational state.

3. The method of claim 2, the method further comprising:
presenting, at a user interface, the execution of the operational state, the operational state being configured to being managed by a user.

4. The method of claim 1, wherein the one or more modes of non-hyperloop transportation are associated with a non-hyperloop route between a hyperloop portal and a non-hyperloop-portal destination.

5. The method of claim 1, wherein the one or more modes of non-hyperloop transportation are selected from the group consisting of: ridesharing, carpool, taxi, automobile, train, trolley, airplane, ship, and ferry.

6. The method of claim 1, the method further comprising:
detecting, at the processor, a level of congestion within the first hyperloop route; and
assigning, at the processor, the first trip model to a third hyperloop route, the third hyperloop route being less congested than the first hyperloop route.

7. The method of claim 1, wherein generating the socio-economic model is based on socio-economic data selected from the group consisting of: population size, employment rate, types of employment, household sizes, number of vehicles per household, income within a region, income sources per household, and existing modes of transportation.

8. The method of claim 1, wherein generating the land use model is based on land use data selected from the group consisting of: land density, land diversity, land value, taxes, zoning, accessibility, existing infrastructure, and encumbrances.

9. The method of claim 1, wherein generating the accessibility model is based on accessibility data selected from the group consisting of: travel duration, portal locations, route locations, road locations, rail locations, port locations, airport locations, housing locations, commercial locations, industrial locations, and government locations.

10. A computing device configured to manage traffic demand within a transportation network, the computing device comprising:
a memory;
a user interface; and
a processor configured to:
generate a socio-economic model;
generate a land use model;
generate an accessibility model;
generate a plurality of trip models, the plurality of trip models comprising a first trip model and a second trip model, the first trip model and the second trip model being based on the socio-economic model, the land use model, the accessibility model, or a combination thereof, the first trip model further having a first hyperloop route associated therewith, the second trip model further having a second hyperloop route associated therewith;
determine a trip distribution of the plurality of trip models, the trip distribution being based on the first hyperloop route and the second hyperloop route;
determine availability of one or more modes of non-hyperloop transportation, the one or more modes of non-hyperloop transportation being associated with the first hyperloop route;
assign the first trip model to a passenger, a cargo unit, or a combination thereof, the first trip model utilizing the one or more modes of non-hyperloop transportation determined to be available during a travel time associated with the first trip model; and
optimize the first hyperloop route based on the one or more modes of non-hyperloop transportation.

11. The computing device of claim 10, the processor being further configured to:
execute an operational state, the operational state causing a first hyperloop pod to travel along the first hyperloop route and a second hyperloop pod to travel along the second hyperloop route, the operational state further notifying the one or more modes of non-hyperloop transportation of the travel time associated with the first trip model;
update the land use model based on the operational state; and
update the accessibility model based on the operational state.

12. The computing device of claim 11, the processor being further configured to:
present, at the user interface, the execution of the operational state, the operational state being configured to being managed by a user.

13. The computing device of claim 10, wherein the one or more modes of non-hyperloop transportation are associated with a non-hyperloop route between a hyperloop portal and a non-hyperloop-portal destination.

14. The computing device of claim 10, wherein the one or more modes of non-hyperloop transportation are selected from the group consisting of: ridesharing, carpool, taxi, automobile, train, trolley, airplane, ship, and ferry.

15. The computing device of claim 10, the processor being further configured to:
detect a level of congestion within the first hyperloop route; and
assign the first trip model to a third hyperloop route, the third hyperloop route being less congested than the first hyperloop route.

16. The computing device of claim 10, wherein generating the socio-economic model is based on socio-economic data selected from the group consisting of: population size, employment rate, types of employment, household sizes, number of vehicles per household, income within a region, income sources per household, and existing modes of transportation.

17. The computing device of claim 10, wherein generating the land use model is based on land use data selected from the group consisting of: land density, land diversity, land value, taxes, zoning, accessibility, existing infrastructure, and encumbrances.

18. The computing device of claim 10, wherein generating the accessibility model is based on accessibility data selected from the group consisting of: travel duration, portal locations, route locations, road locations, rail locations, port locations, airport locations, housing locations, commercial locations, industrial locations, and government locations.

19. A computer-readable medium storing instructions that, when executed by a computer, cause the computer to:
generate, at a processor, a socio-economic model;
generate, at the processor, a land use model;
generate, at the processor, an accessibility model;
generate, at the processor, a plurality of trip models, the plurality of trip models comprising a first trip model and a second trip model, the first trip model and the second trip model being based on the socio-economic model, the land-use model, the accessibility model, or a combination thereof, the first trip model further having a first hyperloop route associated therewith, the second trip model further having a second hyperloop route associated therewith;
determine, at the processor, a trip distribution of the plurality of trip models, the trip distribution being based on the first hyperloop route and the second hyperloop route;
determine, at the processor, availability of one or more modes of non-hyperloop transportation, the one or more modes of non-hyperloop transportation being associated with the first hyperloop route;
assign, at the processor, the first trip model to a passenger, a cargo unit, or a combination thereof, the first trip model utilizing the one or more modes of non-hyperloop transportation determined to be available during a travel time associated with the first trip model; and
optimize, at the processor, the first hyperloop route based on the one or more modes of non-hyperloop transportation.

20. The computer-readable medium of claim 19, the instructions further causing the computer to:
execute, at the processor, an operational state, the operational state causing a first hyperloop pod to travel along the first hyperloop route and a second hyperloop pod to travel along the second hyperloop route, the operational state further notifying the one or more modes of non-hyperloop transportation of the travel time associated with the first trip model;
update, at the processor, the land use model based on the operational state;
update, at the processor, the accessibility model based on the operational state; and
present, at a user interface, the execution of the operational state, the operational state being configured to being managed by a user.
